(19) United States
(12) Patent Application Publication
(10) Pub. No.: US 2021/0105872 A1
(43) Pub. Date: Apr. 8, 2021

(54) COOKING APPARATUS

(71) Applicant: SHARP KABUSHIKI KAISHA, Sakai City, Osaka (JP)

(72) Inventors: MINORU TANAKA, Sakai City (JP); KAORI FUJIMOTO, Sakai City (JP); KEISUKE MORISHITA, Sakai City (JP); IKUO TSUZUKI, Sakai City (JP); KAZUNORI YASUDA, Sakai City (JP); HIROKI MORIKAWA, Sakai City (JP); TAMON MOTOYA, Sakai City (JP); KAZUYUKI NAKO, Sakai City (JP)

(21) Appl. No.: 15/999,659

(22) PCT Filed: Jan. 10, 2017
(86) PCT No.: PCT/JP2017/000412

§ 371 Date: Aug. 20, 2018

(30) Foreign Application Priority Data
Jun. 29, 2016 (JP) 2016-129249

(51) Int. Cl. H05B 6/64

(52) U.S. Cl. CPC H05B 6/6435

(57) ABSTRACT

A cooking apparatus includes a display unit and a display control unit configured to control the display unit. The display control unit controls the display unit to display an advertisement at a time when a user is likely to view a display screen of the display unit.

### TECHNICAL FIELD

The present invention relates to cooking apparatuses.

### BACKGROUND ART

Conventionally, there is a cooking apparatus that displays advertisement information delivered from a server via a network (for example, refer to JP 2001-90953 A (Patent Literature 1)).

The cooking apparatus displays advertisement information on a display unit together with recipe information and/or displays the advertisement information on the display unit at regular time intervals.

### CITATION LIST

### Patent Literature

Patent Literature 1: JP 2001-90953 A

### SUMMARY OF INVENTION

### Technical Problems

Incidentally, in such a cooking apparatus, in which advertisement information is displayed on a display unit together with recipe information and/or at regular time intervals, advertisements may be displayed against a user's will. Accordingly, there is a problem that a user may feel troublesome. Moreover, in such a cooking apparatus, since advertisement contents may not be sufficiently conveyed to the user, there is a problem that effective advertisement notification may be impossible.

An object of the present invention is, therefore, to provide cooking apparatuses capable of making effective advertisement notification without causing the user to feel troublesome.

### Solutions to Problems

A cooking apparatus according to an aspect of the present invention includes a display unit, and a display control unit configured to control the display unit, wherein the display control unit controls the display unit to display an advertisement at a time when a user is likely to view a display screen of the display unit.

In one embodiment, the time when the user is likely to view the display screen of the display unit may include a predetermined period immediately before an end of heating cooking.

In one embodiment, the time when the user is likely to view the display screen of the display unit may be a predetermined period immediately before the end of the heating cooking and after issuance of an advance notice of the end of the heating cooking.

In one embodiment, the time when the user is likely to view the display screen of the display unit may include a predetermined period immediately after a start of the heating cooking.

In one embodiment, the cooking apparatus may further include a heating chamber in which an object to be heated is heated, and a door configured to open and close an opening of the heating chamber, wherein the time when the user is likely to view the display screen of the display unit includes a period from a point of time when the heating cooking is ended until the door is opened and closed.

In one embodiment, the cooking apparatus may include an input operation unit to be operated by the user, and an advertisement information acquisition unit configured to acquire information on the advertisement to be displayed on the display unit from an external information providing device, wherein the advertisement information acquisition unit acquires the information on the advertisement from the information providing device during heating cooking or while the input operation unit is not operated.

In one embodiment, the cooking apparatus may include a history notification unit configured to notify the information providing device of a history of advertisements displayed on the display unit, wherein the advertisement information acquisition unit is capable of acquiring information on an advertisement different from the advertisements displayed on the display unit from the information providing device notified of the history of the advertisement from the history notification unit.

In one embodiment, the cooking apparatus may include a television advertisement information acquisition unit configured to acquire information related to a television advertisement to be displayed on the display unit from an external television advertisement providing device, and a television advertisement interlocking unit configured to interlock timing of displaying, on the display unit, the information related to the television advertisement acquired by the television advertisement information acquisition unit with television broadcasting of the television advertisement, wherein the display control unit controls the display unit to display the information related to the television advertisement acquired by the television advertisement information acquisition unit in conjunction with the television broadcasting of the television advertisement, with aid of the television advertisement interlocking unit.

Moreover, a cooking apparatus according to an aspect of the present invention includes a voice output unit, and a voice output control unit configured to control the voice output unit, wherein the voice output control unit controls the voice output unit to output advertisement information as voice, namely, in the form of voice, at a time when the user is likely to hear a voice output from the voice output unit.

Furthermore, a cooking apparatus according to an aspect of the present invention includes a display unit, a display control unit configured to control the display unit, a television advertisement information acquisition unit configured to acquire information related to a television advertisement to be displayed on the display unit from an external television advertisement providing device, and a television advertisement interlocking unit configured to interlock timing of displaying on the display unit the information related to the television advertisement acquired by the television advertisement information acquisition unit with television broadcasting of the television advertisement, wherein the display control unit controls the display unit to display the information related to the television advertisement acquired by the television advertisement information acquisition unit, in conjunction with the television broadcasting of the television advertisement, with the aid of the television advertisement interlocking unit.

Moreover, a cooking apparatus according to an aspect of the present invention includes a voice input unit configured to receive a voice, a speaking person identification unit configured to identify a speaking person by performing voiceprint authentication based on the voice input by the voice input unit, and a cooking menu proposal unit configured to propose a cooking menu according to the speaking person identified by the speaking person identification unit.

### Advantageous Effects of Invention

As is apparent from the above, according to the present invention, a cooking apparatus can be achieved which is capable of making effective advertisement notification without causing the user to feel troublesome by displaying advertisement at a time when the user is likely to view the display screen of the display unit.

### BRIEF DESCRIPTION OF DRAWINGS

FIG. 1 is a schematic configuration view of a heating cooking system according to a first embodiment of the present invention.

FIG. 2 is an external perspective view of a cooking apparatus of the heating cooking system.

FIG. 3 is a control block diagram of the cooking apparatus.

FIG. 4 is a control block diagram of a management server of the heating cooking system.

FIG. 5 is a control block diagram of a cooking apparatus of a heating cooking system according to a second embodiment of the present invention.

FIG. 6 is a control block diagram of a management server of the heating cooking system.

FIG. 7 is a control block diagram of a cooking apparatus of a heating cooking system according to a third embodiment of the present invention.

FIG. 8 is a control block diagram of a management server of the heating cooking system.

FIG. 9 is a control block diagram of a cooking apparatus of a heating cooking system according to a fourth embodiment of the present invention.

FIG. 10 is a schematic diagram for illustrating delivery setting.

FIG. 11 is a schematic diagram for illustrating voice dialogue.

FIG. 12 is a view showing an example of a screen that displays advertisement.

### DESCRIPTION OF EMBODIMENTS

Hereinafter, a cooking apparatus of the present invention will be detailed with reference to the illustrated embodiments.

### First Embodiment

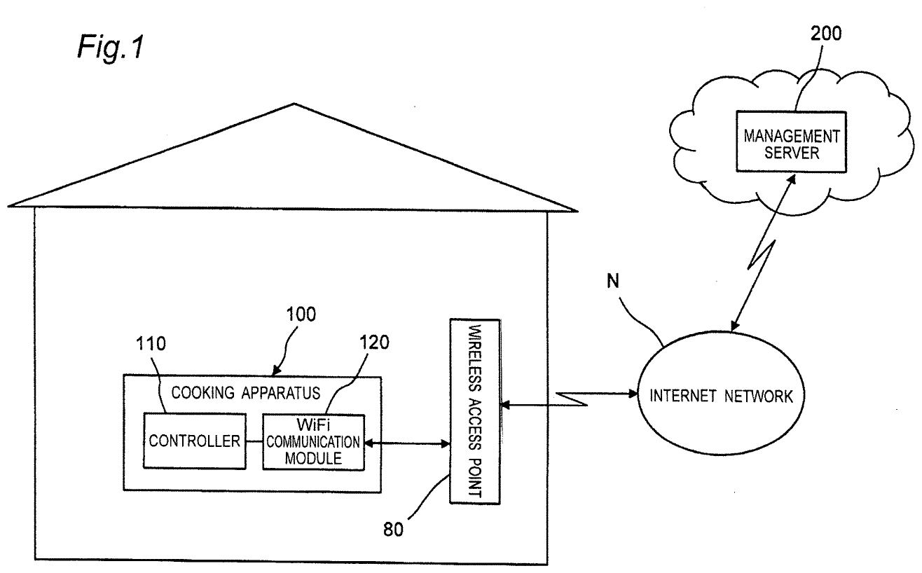

FIG. 1 shows a schematic configuration view of a heating cooking system according to a first embodiment of the present invention.

As shown in FIG. 1, the heating cooking system of the first embodiment includes a cooking apparatus 100 as an example of home electric appliances, and a management server 200 that communicates with the cooking apparatus 100 via the Internet network N.

The management server 200 constitutes a cloud computing system.

The cooking apparatus 100 includes a WiFi communication module 120 that communicates with the management server 200 and the like via a wireless access point 80 and the Internet network N. The Internet network N is an example of a communication network. Note that the WiFi communication module 120 may be directly connected to the Internet network N.

The WiFi communication module 120 makes communication, which is established by a wireless local area network (LAN), with such an indoor wireless access point 80. More specifically, the WiFi communication module 120 transmits and receives information to and from the outdoor management server 200 via the wireless access point 80 using WiFi (registered trademark) which is a wireless LAN standard as an example of a communication standard. Note that other communication standards such as Bluetooth (registered trademark) may be used instead of WiFi.

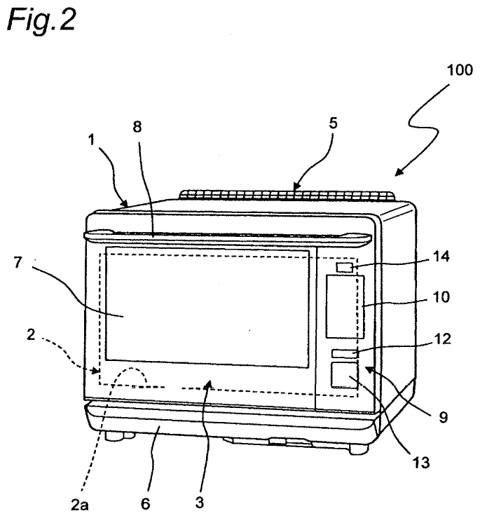

FIG. 2 is an external perspective view of the cooking apparatus 100.

As shown in FIG. 2, the cooking apparatus 100 includes a body casing 1 having a rectangular parallelepiped shape, a heating chamber 2 provided in the body casing 1 and having an opening 2a on a front side, and a door 3 configured to open and close the opening 2a of the heating chamber 2.

An exhaust duct 5 is provided on an upper side and rear side of the body casing 1. Moreover, a dew receiver 6 is detachably attached to a lower portion of a front surface of the body casing 1.

The door 3 is attached to a front side of the body casing 1 so as to be pivotable about a lower side as an axis. A transparent outer glass 7 having heat resistance is provided on a front surface (a surface opposite from the heating chamber 2) of the door 3. Moreover, the door 3 includes a handle 8 located on an upper side of the outer glass 7, and a control panel 9 provided on a right side of the outer glass 7. The control panel 9 is an example of a display unit and an input operation unit.

The control panel 9 includes a color liquid crystal display unit 10, a cancel key 12 to be pressed when heating is stopped midway, and a warming start key 13 to be pressed when heating is started.

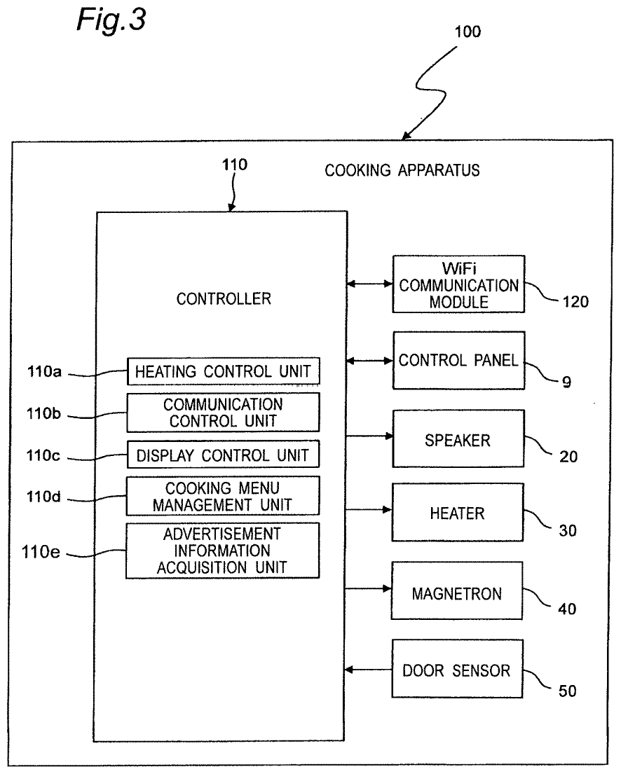

FIG. 3 shows a control block diagram of the cooking apparatus 100. As shown in FIG. 3, the cooking apparatus 100 includes a controller 110. Connected to the controller 110 are the WiFi communication module 120, the control panel 9, a speaker 20, a heater 30, a magnetron 40, a door sensor 50, and the like. The controller 110 controls the WiFi communication module 120, the color liquid crystal display unit 10 of the control panel 9, the speaker 20, the heater 30, the magnetron 40 and the like based on signals from the control panel 9, a humidity sensor (not shown), an internal temperature sensor (not shown), the door sensor 50, and the like. The speaker 20 is an example of the voice output unit.

The controller 110 is constituted mainly of a microcomputer and an input/output circuit, and includes a heating control unit 110a configured to control the heater 30 and the magnetron 40 to perform heating cooking, a communication control unit 110b configured to control the WiFi communication module 120, a display control unit 110c configured to control the color liquid crystal display unit 10, a cooking menu management unit 110d configured to manage information on a cooking menu executable in the cooking apparatus 100, and an advertisement information acquisition unit 110e configured to acquire advertisement information from the management server 200.

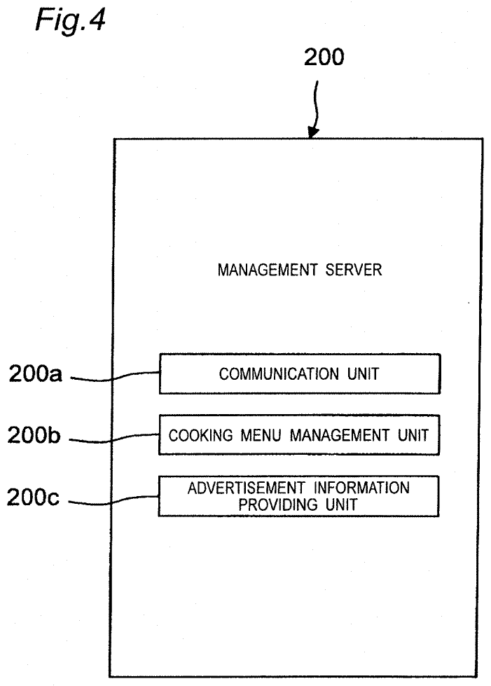

FIG. 4 is a block diagram showing a configuration of the management server 200. As shown in FIG. 4, the management server 200 includes a communication unit 200a configured to perform communication via the Internet network N (shown in FIG. 1), a cooking menu management unit 200b configured to manage information on cooking menus, and an advertisement information providing unit 200c configured to provide advertisement information.

In the cooking apparatus 100 having the above-described configuration, during the heating cooking or while the control panel 9 (input operation unit) is not operated, the advertisement information acquisition unit 110e acquires the advertisement information (still image, moving picture, voice, and the like) from the management server 200 (information providing device). Here, the management server 200 transmits the advertisement information from the advertisement information providing unit 200c to the cooking apparatus 100 via the communication unit 200a, the Internet network N and the wireless access point 80. The advertisement information received by the communication control unit 110b of the controller 110 via the WiFi communication module 120 of the cooking apparatus 100 is acquired by the advertisement information acquisition unit 110e. In this embodiment, it takes about 30 seconds to 40 seconds to download the advertisement information.

Next, based on the advertisement information acquired by the advertisement information acquisition unit 110e, the display control unit 110c controls the color liquid crystal display unit 10 to display the advertisement on the color liquid crystal display unit 10 in a predetermined period immediately before an end of the heating cooking. For example, in the first embodiment, when a remaining heating cooking time reaches one minute, guidance of the end of the cooking is displayed (and output in the form of voice), and when the remaining heating cooking time reaches 30 seconds, the advertisement is displayed on the color liquid crystal display unit 10 for 15 seconds. Thereafter, the remaining heating cooking time is displayed for the remaining 15 seconds. At this time, the speaker 20 issues a notice of the end of the cooking in the form of voice, namely, by voice.

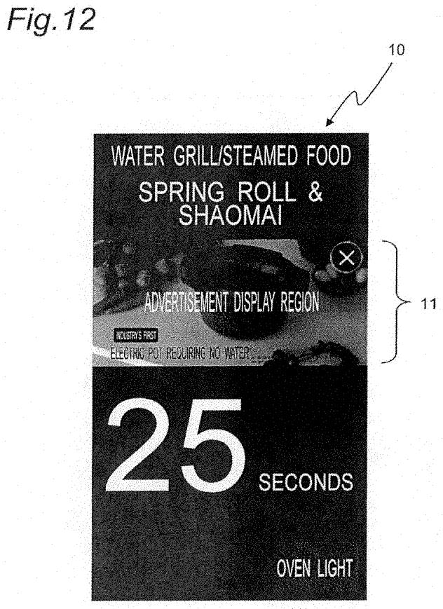

For example, as shown in FIG. 12, the guidance of the end of cooking is displayed (and output in the form of voice) on the screen of the color liquid crystal display unit 10 while “Spring roll & Shaomai” is being cooked by heating, and thereafter, once the remaining heating cooking time reaches 30 seconds, advertisement information 11 (“Electric pot requiring no water”) is displayed.

In the cooking apparatus 100, when cooking does not require a heating cooking time of 1 minute or more, the advertisement is not displayed. However, even when the heating cooking time is less than 1 minute, the advertisement may be displayed.

Moreover, based on the advertisement information acquired by the advertisement information acquisition unit 110e, the advertisement may be displayed on the color liquid crystal display unit 10 in a predetermined period immediately after the start of the heating cooking. For example, in the first embodiment, the advertisement is displayed on the color liquid crystal display unit 10 for 15 seconds after the start of heating cooking, and then a remaining time of the heating cooking is displayed.

Also, based on the advertisement information acquired by the advertisement information acquisition unit 110e, the advertisement may be displayed on the color liquid crystal display unit 10 in a period from a point of time when the heating cooking is ended until when the door 3 is opened and closed. Here, the controller 110 detects the opening/closing of the door 3 based on a signal from the door sensor 50.

In the cooking apparatus 100 of the first embodiment, the display control unit 110c controls the color liquid crystal display unit 10 to display the advertisement at a time when the user is likely to view the display screen of the color liquid crystal display unit 10. Accordingly, effective advertisement display can be performed without causing the user to feel troublesome.

Moreover, immediately before the end of the heating cooking, the user may be near the cooking apparatus 100, so that the display screen of the color liquid crystal display unit 10 may easily meet the user's eyes. Accordingly, the advertisement is displayed on the color liquid crystal display unit 10 in a predetermined period immediately before the end of the heating cooking, whereby more effective advertisement notification can be made.

After a notice of the end of the heating cooking is issued in advance by voice and/or displayed immediately before the end of the heating cooking, the user may come near the cooking apparatus 100, so that the display screen of the display unit 10 may easily meet the user's eyes. Accordingly, the advertisement may be displayed on the color liquid crystal display unit 10 in a predetermined period immediately before the end of the heating cooking and after issuance of such an advance notice of the end of the heating cooking. This makes it possible to make more effective advertisement notification.

Moreover, immediately after the start of the heating cooking, the user may be near the cooking apparatus 100, and the display screen of the color liquid crystal display unit 10 may easily meet the user's eyes. Accordingly, the advertisement is displayed on the color liquid crystal display unit 10 in a predetermined period immediately after the start of the heating cooking, whereby more effective advertisement notification can be made.

Furthermore, the user stands in front of the door 3 without fail in order to take out a food item from the heating chamber in a period from the point of time when the heating cooking is ended until the door 3 is opened and closed. Accordingly, the display screen of the color liquid crystal display unit 10 can easily meet the user's eyes in that period. Hence, the advertisement is displayed on the color liquid crystal display unit 10 in the period from the point of time when the heating cooking is ended until the door 3 is opened and closed, whereby more effective advertisement notification can be made.

Alternatively, when the door sensor 50 detects that the door 3 is opened after the end of the heating cooking, the user is sure to be near the cooking apparatus 100 in order to take out the food item from the heating chamber 2. Therefore, by displaying the advertisement on the color liquid crystal display unit 10 at this time, more effective advertisement notification can be made.

Note that a human sensor configured to detect that the user is nearby may be provided, and when the human sensor detects that the user is near the cooking apparatus 100, the advertisement may be displayed on the color liquid crystal display unit 10.

The advertisement information acquisition unit 110e acquires the advertisement information from the management server 200 (information providing device) during the heating cooking or while the control panel 9 (input operation unit) is not operated. Accordingly, even if a central processing unit (CPU) with a low processing capability is used for the controller, a process for acquiring the advertisement information can be prevented from affecting the control for the heating cooking and the control for the control panel 9. Here, it is assumed that the control panel 9 (input operation unit) is not operated when the control panel 9 is not operated for a certain period of time or longer.

The cooking apparatus 100 of the heating cooking system does not have a clock function. However, since the management server 200 has the clock function and a calendar function, the cooking apparatus 100 can display an advertisement corresponding to a time and a date by the management server 200 providing appropriate advertisement information based on the time and the date. Such an advertisement relates to the three meals of breakfast, lunch and supper, seasonal ingredients, and the like in terms of the time and the date.

The cooking apparatus 100 may be provided with the clock function and the calendar function so as to display a similar advertisement.

The advertisement information may be downloaded from the management server 200 to the cooking apparatus 100, for example, during a time period during which the cooking apparatus 100 is usually not used, whereby it is possible to easily download a large volume of advertisement information of which reception requires a long time. Here, history information on the executed cooking menu may be provided from the cooking apparatus 100 to the management server 200, whereby the management server 200 can know the time period during which the cooking apparatus 100 is usually not usually used.

### Second Embodiment

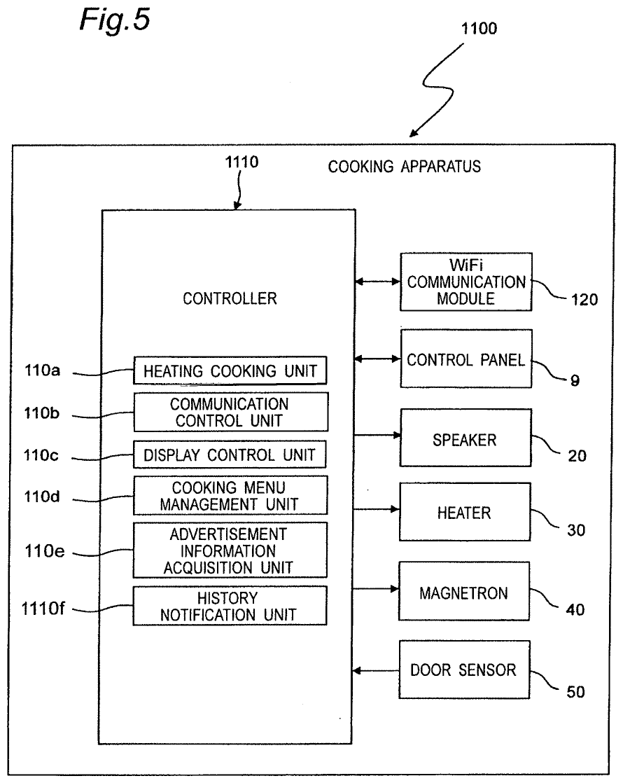

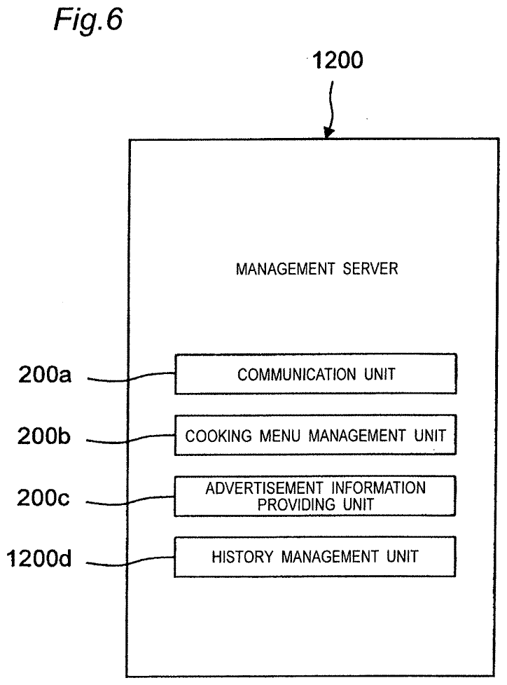

FIG. 5 shows a control block diagram of a cooking apparatus 1100 of a heating cooking system according to a second embodiment of the present invention, and FIG. 6 shows a control block diagram of a management server 1200 of the heating cooking system. The cooking apparatus 1100 of the second embodiment has the same configuration as the cooking apparatus 100 of the first embodiment except for a history notification unit 1110f, the management server 1200 of the second embodiment has the same configuration as the management server 200 of the first embodiment except for a history management unit 1200d. FIGS. 1 to 4 are also used for this embodiment as well.

As shown in FIG. 5, a controller 1110 of the cooking apparatus 1100 of the second embodiment includes the heating control unit 110a, the communication control unit 110b, the display control unit 110c, the cooking menu management unit 110d, the advertisement information acquisition unit 110e, and the history notification unit 1110f configured to notify the management server 1200 (information providing device) of advertisement history information on advertisements displayed on the color liquid crystal display unit 10.

On the other hand, as shown in FIG. 6, the management server 1200 includes the communication unit 200a, the cooking menu management unit 200b, the advertisement information providing unit 200c, and the history management unit 1200d configured to manage the advertisement history information notified from the cooking apparatus 1100.

In the cooking apparatus 1100 having the above configuration, the history notification unit 1110f notifies the management server 1200 of the advertisement history information of the advertisements displayed on the color liquid crystal display unit 10. The history management unit 1200d of the management server 1200 manages the advertisement history information received from the cooking apparatus 1100. Based on the advertisement history information managed by the history management unit 1200d, the advertisement information providing unit 200c selects information on an advertisement different from the advertisements displayed by the cooking apparatus 1100, and the communication unit 200a transmits the selected advertisement information to the cooking apparatus 100 via the Internet network N and the wireless access point 80.

In this way, the advertisement information acquisition unit 110e of the cooking apparatus 1100 is capable of obtaining information on an advertisement, which is different from the advertisements displayed on the color liquid crystal display unit 10, from the management server 1200 notified of the advertisement history information. This makes it possible to prevent the same advertisement from being displayed many times, so that the user can be interested in the advertisement every time.

The cooking apparatus 1100 of the second embodiment has similar effects to those of the cooking apparatus 100 of the first embodiment.

### Third Embodiment

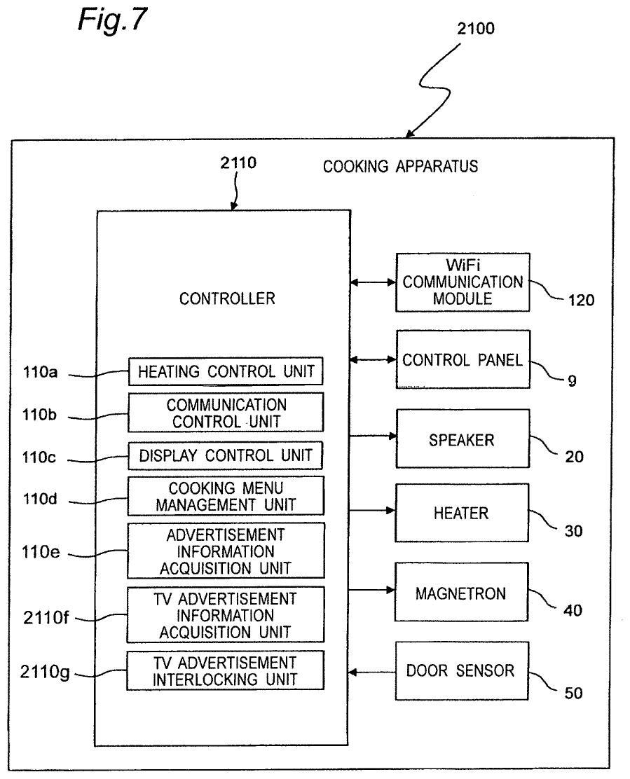

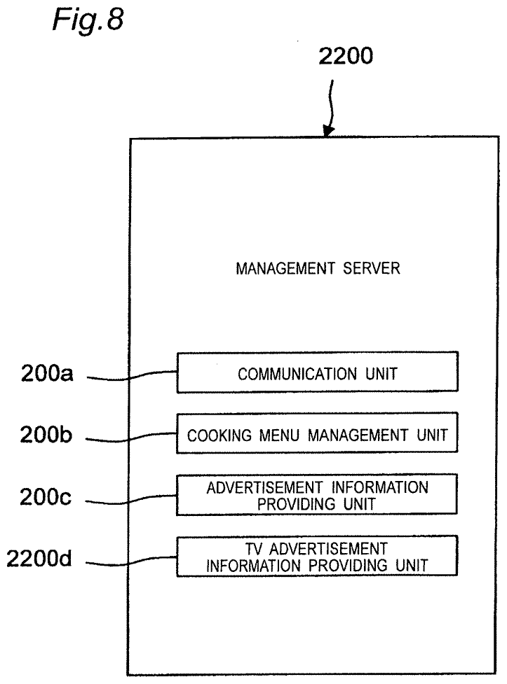

FIG. 7 is a control block diagram of a cooking apparatus 2100 of a heating cooking system according to a third embodiment of the present invention, and FIG. 8 is a control block diagram of a management server 2200 of the heating cooking system. The cooking apparatus 2100 of this embodiment has the same configuration as the cooking apparatus 100 of the first embodiment except for a television advertisement information acquisition unit 2110f and a television advertisement interlocking unit 2110g. The management server 2200 of this embodiment has the same configuration as the management server 200 of the first embodiment except for a television advertisement information providing unit 2200d. FIGS. 1 to 4 are also used for this embodiment as well. Here, the management server 2200 is an example of a television advertisement providing device.

As shown in FIG. 7, a controller 2110 of the cooking apparatus 2100 of the third embodiment includes the heating control unit 110a, the communication control unit 110b, the display control unit 110c, the cooking menu management unit 110d, the advertisement information acquisition unit 110e, the television advertisement information acquisition unit 2110f configured to acquire television advertisement information, which is related to television advertisement and is to be displayed on the color liquid crystal display unit 10, from the management server 2200 (television advertisement providing device), and the television advertisement interlocking unit 2110g configured to interlock timing of displaying on the color liquid crystal display unit 10 the television advertisement information acquired by the television advertisement information acquisition unit 2110f with television broadcasting of the television advertisement.

On the other hand, as shown in FIG. 8, the management server 2200 includes the communication unit 200a, the cooking menu management unit 200b, the advertisement information providing unit 200c, and the television advertisement information providing unit 2200d configured to provide the information related to the television advertisement to the cooking apparatus 2100. The information related to the television advertisement and provided by the television advertisement information providing unit 2200d is, for example, advertisement information (deal information or the like) created in accordance with a television advertisement of a television-broadcasted commodity and in order to be displayed on the cooking apparatus 210 in association with the commodity.

In the cooking apparatus 210 having the above configuration, the television advertisement information acquisition unit 2110f acquires the information related to the television advertisement to be displayed on the color liquid crystal display unit 10, from the management server 2200 (television advertisement providing device). Then, the color liquid crystal display unit 10 is controlled to display the information, which is related to the television advertisement and acquired by the cooking apparatus 210, at the timing interlocked with the television broadcasting of the television advertisement by the television advertisement interlocking unit 2110g. This makes it possible to make far more effective advertisement notification.

The cooking apparatus 2100 of the third embodiment has similar effects to those of the cooking apparatus 100 of the first embodiment.

Note that, in the third embodiment, the information related to the television advertisement is displayed on the color liquid crystal display unit 10 in conjunction with the television broadcasting of the television advertisement; however, information related to a television advertisement scheduled to be broadcasted within a predetermined time may be displayed on the display unit.

For example, information related to a television advertisement scheduled to be broadcasted in a few minutes may be displayed, whereby the user can be guided to the television advertisement broadcasted on television.

### Fourth Embodiment

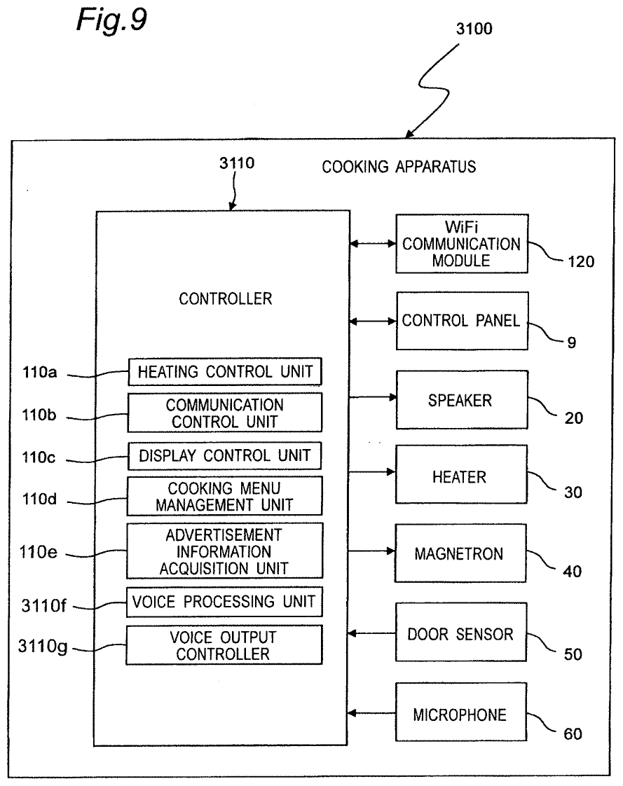

FIG. 9 is a control block diagram of a cooking apparatus 3100 of a heating cooking system according to a fourth embodiment of the present invention. The cooking apparatus 3100 of the fourth embodiment has the same configuration as the cooking apparatus 100 of the first embodiment except for a voice processing unit 3110f and a voice output control unit 3110g, and FIG. 1, FIG. 2 and FIG. 3 are also used for this embodiment.

As shown in FIG. 9, a controller 3110 of the cooking apparatus 3100 according to the fourth embodiment includes the heating control unit 110a, the communication control unit 110b, the display control unit 110c, the cooking menu management unit 110d, the advertisement information acquisition unit 110e, the voice processing unit 3110f configured to process a voice signal input to a microphone 60 as an example of an voice input unit, and the voice output control unit 3110g configured to output a voice signal to a speaker 20 as an example of the voice output unit.

In the cooking apparatus 3100 having the above-described configuration, during the heating cooking or while the control panel 9 (input operation unit) is not operated, the advertisement information acquisition unit 110e acquires advertisement information from the management server 200 (information providing device). Here, the management server 200 transmits the advertisement information from the advertisement information providing unit 200c to the cooking apparatus 3100 via the communication unit 200a, the Internet network N and the wireless access point 80. The advertisement information received by the communication control unit 110b of the controller 110 via the WiFi communication module 120 of the cooking apparatus 3100 is acquired by the advertisement information acquisition unit 110e. It takes about 30 seconds to 40 seconds to download the advertisement information.

Next, based on the advertisement information acquired by the advertisement information acquisition unit 110e, the voice processing unit 3110f outputs the advertisement information in the form of voice from the speaker 20 in a predetermined period immediately before the end of the heating cooking. If the heating cooking does not require a heating time of 1 minute or more, the advertisement information is not output in the form of voice from the speaker 20.

In the cooking apparatus 3100, when the heating cooking does not require a heating time of 1 minute or more, the advertisement information is not output in the form of voice from the speaker 20. However, even when the heating cooking time is less than 1 minute, the advertisement information may be output in the form of voice from the speaker 20.

Based on the advertisement information acquired by the advertisement information acquisition unit 110e, the advertisement information is output in the form of voice from the speaker 20 in a predetermined period immediately after the start of the heating cooking.

Moreover, based on the advertisement information acquired by the advertisement information acquisition unit 110e, the advertisement information is output in the form of voice from the speaker 20 in a predetermined period from the point of time when the heating cooking is ended until the door 3 is opened and closed.

In accordance with the cooking apparatus 3100 having the above configuration, the advertisement information is output in the form of voice by the speaker 20 when there is a high possibility that the user hears the voice output from the speaker 20 (voice output unit) by the voice processing unit 3110f. Accordingly, effective advertisement notification can be made without causing the user to feel troublesome.

The cooking apparatus 3100 of the fourth embodiment has similar effects to those of the cooking apparatus 100 of the first embodiment.

### Fifth Embodiment

A cooking apparatus 3100 of a heating cooking system of a fifth embodiment of the present invention has the same configuration as the cooking apparatus 3100 of the fourth embodiment except for an operation of the voice processing unit 3110f, and FIG. 1, FIG. 2, FIG. 3 and FIG. 9 are used for this embodiment.

In the cooking apparatus 3100 according to the fifth embodiment, based on the voice input to the microphone 60, the voice processing unit 3110f performs voiceprint authentication to identify a speaking person. Here, each of users preliminarily inputs a predetermined word or words in the form of voice to the microphone 60 to have their voiceprints registered in the voice processing unit 3110f. The voice processing unit 3110f is an example of a speaking person identification unit.

Then, by identifying the speaking person, a cooking menu suitable for each one of a plurality of users (e.g., father, mother, child and the like) is displayed on the color liquid crystal display unit 10 by the cooking menu management unit 110d (proposal of recommended menu). In this way, a recommended cooking menu according to the user can be proposed. The cooking menu management unit 110d is an example of a cooking menu proposal unit.

The cooking apparatus 3100 is provided with a function to perform an input operation by voice input to the microphone 60. For example, input of a heating method (microwave heating, heater heating, steaming and the like), a cooking menu, ingredients, a heating time and the like can be made by the voice input.

When the speaking person is identified as a child using the voiceprint authentication by the voice processing unit 3110f, the input operation is locked so as to prevent the child from being injured by an accidental operation caused by his or her voice input. As a result, a safer cooking apparatus can be implemented.

The cooking apparatus 3100 of the fifth embodiment has similar effects to those of the cooking apparatus 3100 of the fourth embodiment.

### Sixth Embodiment

A cooking apparatus 3100 of a heating cooking system according to a sixth embodiment of the present invention has the same configuration as the cooking apparatus 3100 of the fourth embodiment except for an operation of the voice processing unit 3110f. A management server 200 of the sixth embodiment has the same configuration as the management server 200 of the first embodiment except for an operation of the advertisement information providing unit 200c. FIG. 1 to FIG. 4 and FIG. 9 are used for this embodiment as well.

In the cooking apparatus 3100 according to the sixth embodiment, the voice processing unit 3110f performs voice recognition based on the voice input to the microphone 60.

Hereinafter, downloading advertisement information from the management server 200 to the cooking apparatus 3100 is referred to as “delivery of advertisement information”.

### Delivery Setting of Advertisement Information

The cooking apparatus 3100 has a function to perform an input operation by the voice input to the microphone 60, and before the delivery of advertisement information, the management server 200 issues an advance notice (advance notice delivery by display or voice) indicating that the advertisement information will be delivered. The information of the advance notice is transmitted to the cooking apparatus 3100 from the advertisement information providing unit 200c of the management server 200 that distributes the advertisement information.

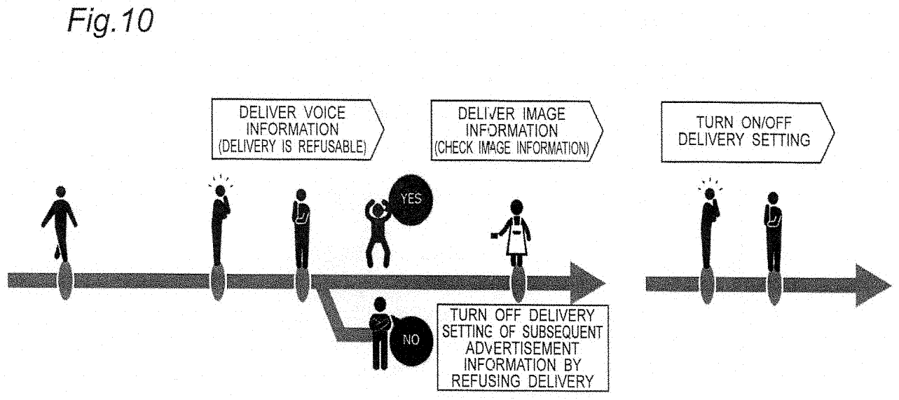

Then, in response to the advance notice, the user can refuse or accept the delivery of the advertisement information by the voice input or the operation of the control panel 9 (input operation unit). When the delivery of the advertisement information is refused, the advertisement information is not delivered, and when the delivery of the advertisement information is accepted, the advertisement information is delivered (see FIG. 10).

In the cooking apparatus 3100, even when the delivery of the advertisement information is accepted in response to the advance notice, it is also possible to change the setting so as not to receive the delivery of the advertisement information later.

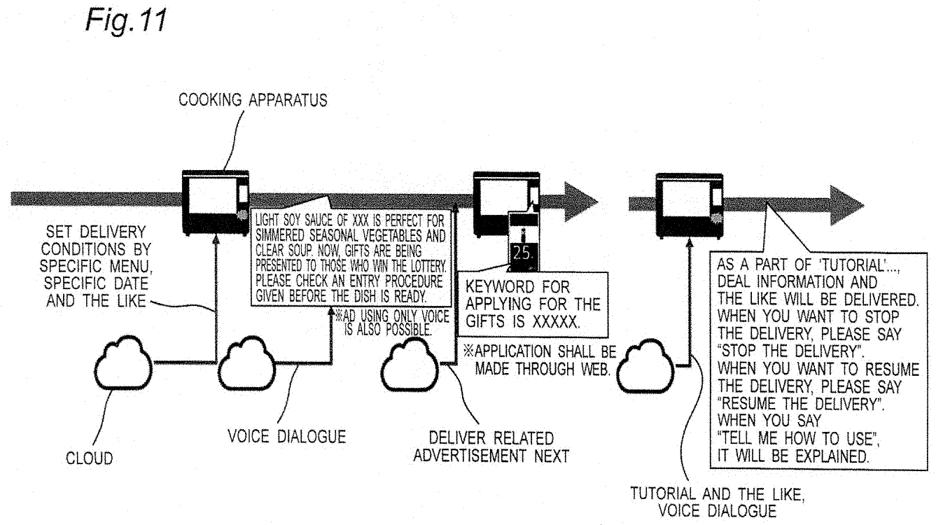

Moreover, as shown in FIG. 11, on a cloud side (management server 200 side), it is possible to set conditions (such as particular cooking menu, particular date and the like) for the delivery of the advertisement information. For example, if the history information of executed cooking menus is received from the cooking apparatus 3100 by the management server 200, and it is determined in the management server 200 that cooking using soy sauce has been frequently done, then a piece or pieces of advertisement information related to soy sauce are appropriately selected from the advertisement information related to soy sauce, such as demand of such a soy sauce advertisement, an advertisement of a new product of soy sauce, a soy sauce advertisement of a leaflet of a neighboring supermarket, and the like, and the selected advertisement information is delivered.

### Voice Dialogue

Each of the cloud side (the management server 200 side) and the cooking apparatus 3100 has a voice dialogue function to interact with the other by voice.

When the advertisement information arrives, the cooking apparatus 3100 informs the user of the arrival of the advertisement by displaying on the color liquid crystal display unit 10 (and outputting by voice) a message such as “advertisement has arrived”. Moreover, a message “Will you listen to the advertisement, or not?” may be displayed on the color liquid crystal display unit 10 (and the message may also be output in the form of voice), whereby the user is guided to select whether to display the advertisement by a selection button displayed on the control panel 9.

Then, when the advertisement display is selected, then for example, the following is displayed in an example of the advertisement of FIG. 11: “Light soy sauce of xxx is perfect for simmered seasonal vegetables and clear soup. Now, gifts are being presented to those who win the lottery. Please check an entry procedure given before the dish is ready.” Note that an advertisement using only voice is also possible depending on an operation mode.

Then, an advertisement related to the above is delivered next, and “The keyword for applying for the gifts is xxxxx” may be displayed. Note that the application shall be made through the WEB.

### Tutorial

Moreover, when the cooking apparatus 3100 is asked by the user for a tutorial or usage, the cooking apparatus 3100 informs the user of a setting method for switching on and off the delivery of the advertisement information in answer.

For example, in FIG. 11, the following message may be displayed: “As a part of ‘tutorial’. . . , deal information and the like will be delivered. When you want to stop the delivery, please say ‘stop the delivery’. When you want to resume the delivery, please say ‘resume the delivery’. When you say ‘tell me how to use’, it will be explained again.”

In the voice dialogue, it is possible to switch on and off the delivery setting for the advertisement information.

The cooking apparatus 3100 of the sixth embodiment has similar effects to those of the cooking apparatus 3100 of the fourth embodiment.

In each of the first to sixth embodiments, the cooking apparatuses that display the advertisement on the display unit has been described; however, each of the embodiments may be applied to a cooking apparatus that makes advertisement notification by voice alone.

Moreover, in each of the first to sixth embodiments, the cooking apparatus to which the advertisement is delivered has been described. However, the information to be delivered is not limited to the advertisement, and recommended ingredients, cooking menu and useful information, which are according to a user's taste, may be delivered.

For example, the cooking apparatus of the present invention is not limited to the oven range including the magnetron and the heater, and may be another cooking apparatus such as a microwave heating-type microwave oven and a rice cooker.

Although the specific embodiments of the present invention have been described, the present invention is not limited to the above-described first to sixth embodiments, and various modifications can be made within the scope of the present invention. For example, an appropriate combination of the contents described in the first to sixth embodiments may be one embodiment of the present invention.

The present invention and the embodiments will be summarized as follows.

A cooking apparatus of the present invention includes:
a display unit 10; and
a display control unit 110c configured to control the display unit 10,
wherein the display control unit 110c controls the display unit 10 to display an advertisement at a time when a user is likely to view a display screen of the display unit 10.

With the above configuration, the display control unit 110c controls the display unit 10 to display the advertisement at the time when the user is likely to view the display screen of the display unit 10. Accordingly, effective advertisement notification can be performed without causing the user to feel troublesome.

In a cooking apparatus according to one embodiment, the time when the user is likely to view the display screen of the display unit 10 includes a predetermined period immediately before an end of heating cooking.

In the above embodiment, immediately before the end of the heating cooking, the user may be near the cooking apparatus, so that the display screen of the display unit 10 may easily meet the user's eyes. Accordingly, the advertisement is displayed on the display unit 10 in a predetermined period immediately before the end of the heating cooking, whereby more effective advertisement notification can be made.

Moreover, in a cooking apparatus according to one embodiment, the time when the user is likely to view the display screen of the display unit is a predetermined period immediately before the end of the heating cooking and after issuance of an advance notice of the end of the heating cooking.

In the above embodiment, after the advance notice of the end of the heating cooking is issued immediately before the end of the heating cooking, the user may be near the cooking apparatus, and the display screen of the display unit 10 may easily meet the user's eyes. Accordingly, more effective advertisement notification can be made.

In a cooking apparatus according to one embodiment, the time when the user is likely to view the display screen of the display unit 10 includes a predetermined period immediately after a start of the heating cooking.

In the above embodiment, immediately after the start of the heating cooking, the user may be near the cooking apparatus, and the display screen of the display unit 10 may easily meet the user's eyes. Accordingly, the advertisement is displayed on the display unit 10 in a predetermined period immediately after the start of the heating cooking, whereby more effective advertisement notification can be made.

In one embodiment, the cooking apparatus includes a heating chamber 2 in which an object to be heated is heated, and a door 3 configured to open and close an opening of the heating chamber 2, wherein the time when the user is likely to view the display screen of the display unit 10 includes a period from a point of time when the heating cooking is ended until the door 3 is opened and closed.

In the above embodiment, the user stands in front of the door 3 without fail in order to take out a food item from the heating chamber 2 in a period from the point of time when the heating cooking for heating the object to be heated in the heating chamber 2 is ended until the door 3 is opened and closed. Accordingly, the display screen of the display unit 10 can easily meet the user's eyes. Hence, the advertisement is displayed on the display unit 10 during the above period, whereby more effective advertisement notification can be made.

In one embodiment, the cooking apparatus includes an input operation unit 9 operable by the user, and an advertisement information acquisition unit 110e configured to acquire information on the advertisement to be displayed on the display unit 10 from an external information providing device 200, wherein the advertisement information acquisition unit 110e acquires the information on the advertisement from the information providing device 200 during heating cooking or while the input operation unit 9 is not operated.

In the above embodiment, the advertisement information acquisition unit 110e acquires the advertisement information from the information providing device 200 during the heating cooking or while the input operation unit 9 is not operated. Accordingly, even if a central processing unit (CPU) with a low processing capability is used for the controller, a process for acquiring the advertisement information can be prevented from affecting the control for the heating cooking and the control for the input operation unit 9.

In one embodiment, the cooking apparatus includes a history notification unit 1110f configured to notify the information providing device 1200 of a history of advertisements displayed on the display unit 10, wherein the advertisement information acquisition unit 110e is capable of acquiring information on an advertisement different from the advertisements displayed on the display unit 10 from the information providing device 1200 notified of the history of the advertisement from the history notification unit 1110f.

In the above embodiment, the history notification unit 1110f notifies the information providing device 1200 of the history of the advertisements displayed on the display unit 10, and the advertisement information acquisition unit 110e is capable of acquiring information on an advertisement different from the advertisements displayed on the display unit 10 from the information providing device 1200 notified of the history of the advertisements, whereby the same advertisement can be prevented from being displayed many times, and the user can be interested in the advertisement every time.

Furthermore, in one embodiment, the cooking apparatus includes a television advertisement information acquisition unit 2110f configured to acquire information related to a television advertisement to be displayed on the display unit 10 from an external television advertisement providing device 2200, and a television advertisement interlocking unit 2110g configured to interlock timing of displaying, on the display unit 10, the information related to the television advertisement acquired by the television advertisement information acquisition unit 2110f with television broadcasting of the television advertisement, wherein the display control unit 110c controls the display unit 10 to display the information related to the television advertisement acquired by the television advertisement information acquisition unit 2110f in conjunction with the television broadcasting of the television advertisement, with aid of the television advertisement interlocking unit 2110g.

In the above embodiment, the information related to the television advertisement to be displayed on the display unit 10 is acquired from the external television advertisement providing device 2200 by the television advertisement information acquisition unit 2110f, and the acquired information related to the television advertisement is displayed on the display unit 10 in conjunction with the television broadcasting of the television advertisement with the aid of the television advertisement interlocking unit 2110g. Accordingly, more effective advertisement notification can be made.

Moreover, a cooking apparatus according to the present invention includes a voice output unit 20, and a voice output control unit 3110g configured to control the voice output unit 20, wherein the voice output control unit 3110g controls the voice output unit 20 to output advertisement information as voice, namely, in the form of voice, at a time when the user is likely to hear the voice output from the voice output unit 20.

With the above configuration, the voice output control unit 3110g controls the voice output unit 20 to output the advertisement information as voice when the user is likely to hear the voice output from the voice output unit 20. Accordingly, effective advertisement notification can be made without causing the user to feel troublesome.

Furthermore, a cooking apparatus according to the present invention includes:

a display unit 10;

a display control unit 110c configured to control the display unit 10;

a television advertisement information acquisition unit 2110f configured to acquire information related to a television advertisement to be displayed on the display unit 10 from an external television advertisement providing device 2200; and

a television advertisement interlocking unit 2110g configured to interlock timing of displaying on the display unit 10 the information related to the television advertisement acquired by the television advertisement information acquisition unit 2110f with television broadcasting of the television advertisement,

wherein the display control unit 110c controls the display unit 10 to display the information related to the television advertisement acquired by the television advertisement information acquisition unit 2110f, in conjunction with the television broadcasting of the television advertisement, with the aid of the television advertisement interlocking unit 2110g.

With the above configuration, the information related to the television advertisement to be displayed on the display unit 10 is acquired from the external television advertisement providing device 2200 by the television advertisement information acquisition unit 2110f, and the acquired information related to the television advertisement is displayed on the display unit 10 in conjunction with the television broadcasting of the television advertisement, with the aid of the television advertisement interlocking unit 2110g. Accordingly, effective advertisement notification can be made.

Moreover, a cooking apparatus according to the present invention includes a voice input unit configured to receive a voice, a speaking person identification unit configured to identify a speaking person by performing voiceprint authentication based on the voice input by the voice input unit, and a cooking menu proposal unit configured to propose a cooking menu appropriate for the speaking person identified by the speaking person identification unit.

With above configuration, an optimum, recommended cooking menu may be proposed for the speaking person identified by performing the voiceprint authentication by the speaking person identification unit based on the voice input by the voice input unit.

### REFERENCE SIGNS LIST

1 body casing

2 heating chamber

3 door

5 exhaust duct

6 dew receiver

7 outer glass

8 handle

9 control panel

10 color liquid crystal display unit

12 cancel key

13 start key

14 NFC communication antenna unit

20 speaker

30 heater

40 magnetron

50 door sensor

80 wireless access point

100, 1100, 2100, 3100 cooking apparatus

110 controller

110a heating control unit

110b communication control unit

110c display control unit

110d cooking menu management unit

110e advertisement information acquisition unit

120 WiFi communication module

200, 1200, 2200 management server

200a communication unit

200b cooking menu management unit

200c advertisement information providing unit

1110f history notification unit

1200d history management unit

2110f television advertisement information acquisition unit

2110g television advertisement interlocking unit

2200d television advertisement information providing unit

3110f voice processing unit

3110g voice output control unit

N Internet network

1. A cooking apparatus comprising:
a display unit; and
a display control unit configured to control the display unit,
wherein the display control unit controls the display unit to display an advertisement at a time when a user is likely to view a display screen of the display unit.

2. The cooking apparatus according to claim 1, wherein the time when the user is likely to view the display screen of the display unit includes a predetermined period immediately before an end of heating cooking.

3. The cooking apparatus according to claim 2, wherein the time when the user is likely to view the display screen of the display unit is a predetermined period immediately before the end of the heating cooking and after issuance of an advance notice of the end of the heating cooking.

4. The cooking apparatus according to claim 1, wherein the time when the user is likely to view the display screen of the display unit includes a predetermined period immediately after a start of heating cooking.

5. The cooking apparatus according to claim 1, further comprising:
a heating chamber in which an object to be heated is heated; and
a door configured to open and close an opening of the heating chamber,
wherein the time when the user is likely to view the display screen of the display unit includes a period from a point of time when heating cooking is ended until the door is opened and closed.

6. The cooking apparatus according to claim 1, further comprising:
an input operation unit to be operated by the user; and
an advertisement information acquisition unit configured to acquire information on an advertisement to be displayed on the display unit from an external information providing device,
wherein the advertisement information acquisition unit acquires the information on the advertisement from the information providing device during heating cooking or while the input operation unit is not operated.

7. The cooking apparatus according to claim 6, further comprising a history notification unit configured to notify the information providing apparatus of a history of advertisements displayed on the display unit,
wherein the advertisement information acquisition unit is capable of acquiring information on an advertisement different from the advertisements displayed on the display unit from the information providing device notified of the history of the advertisements from the history notification unit.

8. The cooking apparatus according to claim 1, further comprising:
a television advertisement information acquisition unit configured to acquire information related to a television advertisement to be displayed on the display unit from an external television advertisement providing device; and
a television advertisement interlocking unit configured to interlock timing of displaying, on the display unit, the information related to the television advertisement acquired by the television advertisement information acquisition unit with television broadcasting of the television advertisement,
wherein the display control unit controls the display unit to display the information related to the television advertisement acquired by the television advertisement information acquisition unit in conjunction with the television broadcasting of the television advertisement, with aid of the television advertisement interlocking unit.
